(19) United States
(12) Patent Application Publication
(10) Pub. No.: US 2017/0069030 A1
(43) Pub. Date: Mar. 9, 2017

(54) ONLINE SOCIAL NETWORK SYSTEM AND METHOD FOR COLLABORITIVE RISK SHARING

(71) Applicant: 1760093 ALBERTA INC., Calgary (CA)

(72) Inventor: Jason Alleyne, Toronto (CA)

(21) Appl. No.: 15/122,611

(22) PCT Filed: Jun. 27, 2014
(86) PCT No.: PCT/IB2014/062665

§ 371 Date: Aug. 30, 2016

(51) Int. Cl. G06Q 40/06; G06Q 40/08; G06Q 20/10

(52) U.S. Cl. CPC G06Q 40/06; G06Q 20/102; G06Q 40/08; G06Q 50/01

(57) ABSTRACT

A system and method for collaborative risk sharing within a peer-to-peer social network is provided. The system and method allows transparent participation in event pools with other participating members who agree to in the same risk. Benefits are paid to participating members who receive a valid loss associated with the shared risk from enrolment funds paid by all participating members within the event pool. Funds received from participating members of one event group are not used to pay benefits to members of another event pool.

### FIELD OF THE INVENTION

The present invention relates generally to risk sharing. More particularly, the invention relates to an online social network system and method for collaborative risk sharing of risk exposure events between members of an event pool.

### BACKGROUND OF THE INVENTION

Present technology does not allow peers, especially those in multiple geographical regions, to share their risk in a simple and transparent way. The most common method of sharing risk is through the purchase of an insurance policy, which is underwritten by a formally regulated entity in a single geopolitical region.

However, that is not a true sharing of risk. The purchase of an insurance policy involves the individual transferring most of the financial risk to the insurance company in return for a payment (the premium). The insurer provides a guarantee even if only one person bought this type of policy. The insurance company bears the risk that not enough people enter the pool to share the risk. That requires the insurance company to protect itself both from a low number of purchasers and from purchasers who know that they are likely to claim. To ensure that there are sufficient purchasers, the insurance companies develop policies which cover individuals with perhaps dissimilar risks e.g. purchasers at various ages. To protect against anti-selection by the purchaser who is aware of an existing medical/health condition or risk exposure that makes insurance very attractive there are expensive and time consuming medical tests and questionnaires. The need for protective legal language in insurance contracts and an onboarding process that is fearful of anti-selection has led to both an expensive and unfriendly consumer purchasing process.

That unfriendly consumer purchasing process has resulted in a large group of people with risks who have not insured their risks. It also means that certain risks and lower dollar value of risks that cannot be insured because the cost of screening customers is too expensive for the insurance company to provide insurance for risks with lower amounts of potential financial loss. Industry experts estimate that the financial exposure of the under-insured just for life insurance is in the trillions of USD in North America alone.

Another obstacle of the traditional insurance model is that it requires a minimum size of insurance due to the overhead of the distribution model, the cost of regulatory compliance and the size of the insurer's operations (the onboarding process to “prevent” anti-selection). This generally means that there is a considerable barrier to entry for the age group 18-45 in the products available due to affordability (as well products are limited to a rigid set of insurance concepts delineated by Life/Health/Property&Casualty). Not surprisingly, these products have a value proposition (price) that is not well perceived, and this group is not pro-actively targeted by the traditional sales agent.

### SUMMARY OF THE INVENTION

The present invention is a system and method that overcomes the drawbacks now existing and provides a peer-to-peer approach for managing risk. A true peer-to-peer approach has never been achieved previously because the cost of finding peers with similar risks and ensuring that participant had a similar possibility of loss was a considerable barrier. The method and apparatus disclosed herein will draw upon new technology in online web platforms and social media tools to connect, educate and direct commercial activity between large groups of underinsured people (across large geographies) towards a common good. The problem that this invention solves is to remove the barriers (both real and perceived) such that the under-insured population can find one another to learn from their collective experience and acquire protection cost effectively and transparently.

Peers participating in the invention will still have a stake in the risk, since they continue to share in the risk. In all instances by design the protection provided will be only partial, therefore, each participant must and will actively avoid the risk because by definition the insurable event on its own is disruptive and unappealing. Further, provided system is transparent about the outcome of the risk. In the traditional model, the insurance purchasers do not know the outcome of all the purchasers of their insurance policy. At best, the policyholder learns the outcome at the aggregate level for the insurance company. Conversely the invention, the members partake in any gains from good experience of the risk pool (namely if actual claims are less than some statistical variance from the expected).

Generally, in one aspect, a method for collaborative risk sharing is provided. The method includes:

(a) establishing, by a processor based system, an event pool for agreeing to share risk with the occurrence of a risk event;

(b) defining, by said processor based system, attributes of the event pool, including a member enrollment fee, the number of member participants, the term of the event pool, and a claim benefit;

(c) registering, by said processor based system, member participants to the event pool that agree to share risk associated with the risk event, each member participant having a funds account from which funds may be withdrawn;

(d) funding an event pool fund account, by said processor based system, by withdrawing the member enrollment fee from the funds account of each member participant and depositing those funds in the event pool fund account that is associated with the event pool;

(e) receiving, by said processor based system, a claim request from a member participant to pay a claim associated with the risk event;

(f) validating, by said processor based system, the received claim request by each member participant;

(g) calculating, by said processor based system, a claim share for each member participant, wherein the claim share is calculated by dividing the claim benefit by the number of member participants;

(h) withdrawing, by said processor based system, the total calculated claim share from the event pool fund account; and

(i) crediting, by said processor based system, the total calculated claim share to a benefit account of the member participant who submitted the claim request.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The following drawings illustrate by way of example and are included to provide further understanding of the invention for the purpose of illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature of a feature with similar functionality. In the drawings:

FIG. 1 schematically shows a computer system for implementing an embodiment disclosed herein;

FIG. 2 diagrammatically illustrates a web portal for implementing an embodiment disclosed herein;

FIG. 3 is a flow-chart illustrating an exemplary user experience of a first time user visiting the web portal and joining the risk pool network (dub) according to an embodiment disclosed herein;

FIG. 4 is a flow-chart illustrating an exemplary process of new member enrollment to the network according to an embodiment disclosed herein;

FIG. 5 representatively illustrates a member record according to an embodiment disclosed herein;

FIG. 6 representatively illustrates a member group record related to a risk pool for a specified risk event according to an embodiment disclosed herein;

FIG. 7 is a flow-chart illustrating an exemplary process of member selecting a risk pool member group to participate in according an embodiment disclosed herein:

FIG. 8 is a flow-chart illustrating an exemplary process of member registering to participate in a selected risk pool member group according an embodiment disclosed herein:

FIG. 9 is a flow-chart illustrating an exemplary process of member creating a new risk pool member group according an embodiment disclosed herein; and

FIG. 10 is a flow-chart illustrating an exemplary process of member participation in a risk pool member group according an embodiment disclosed herein.

### DETAILED DESCRIPTION OF THE INVENTION

A new risk sharing system and method are described herein that uses online social networking to bring together members across different geographical and geopolitical boundaries to participate in member groups for sharing risk among themselves and to learn about and improve risk management. Members of a risk sharing group agree to provide payments to one another in the event that one of the members suffers a loss due to a specified event. The system and method described herein provides the means for members to collaborate in creating and managing member groups for sharing risk with specified risk events.

Particularly, a platform is provide that enables learning about risk management by creating an event pool for risks to be distributed with actuarial fairness among peers who are in multiple geopolitical regions but who have similar financial means and exposures. Uniquely, the system and method uses real economic consequences in a transparent and open platform to allow greater understanding of personal financial risk management. That is, peers, whether individuals, groups, or companies, can jointly share in one another's risks in which the potential risk of financial loss to any one participant is reduced. The financial risk is defined to allow individuals to participate fairly with the possibility that any gains can also be shared equitably when the risk impact is less than expected.

The system and method describe herein utilizes existing online social networks and internet media functions to drive individuals to the platform and connect them together according to similar attributes, such as, for example, risk management needs.

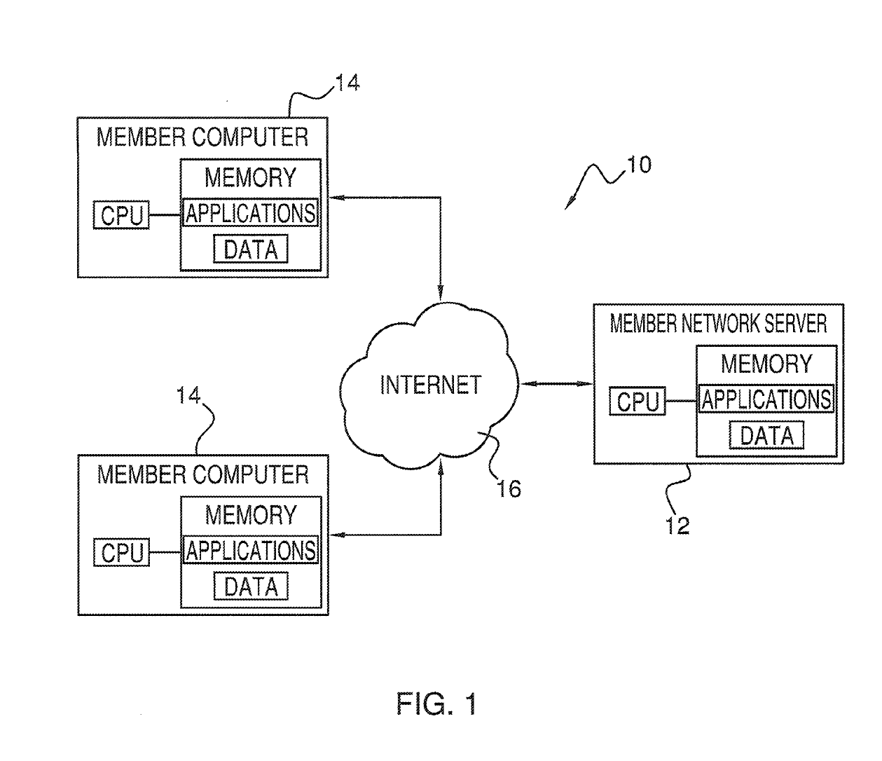

Referring to FIG. 1, a system according to an embodiment is shown and designated as 100. The overall system and method relies on the interaction and information exchange between the member network server 102 and members via member computers 104 that are connected to the member network server by a communications network 106, e.g., the Internet. Each of the member network server 102 and the member computers 104 has a CPU that is connected to memory, a display (not shown), a user input device (e.g., keyboard, touch screen, pointing device, etc.—not shown). Each memory includes applications and data.

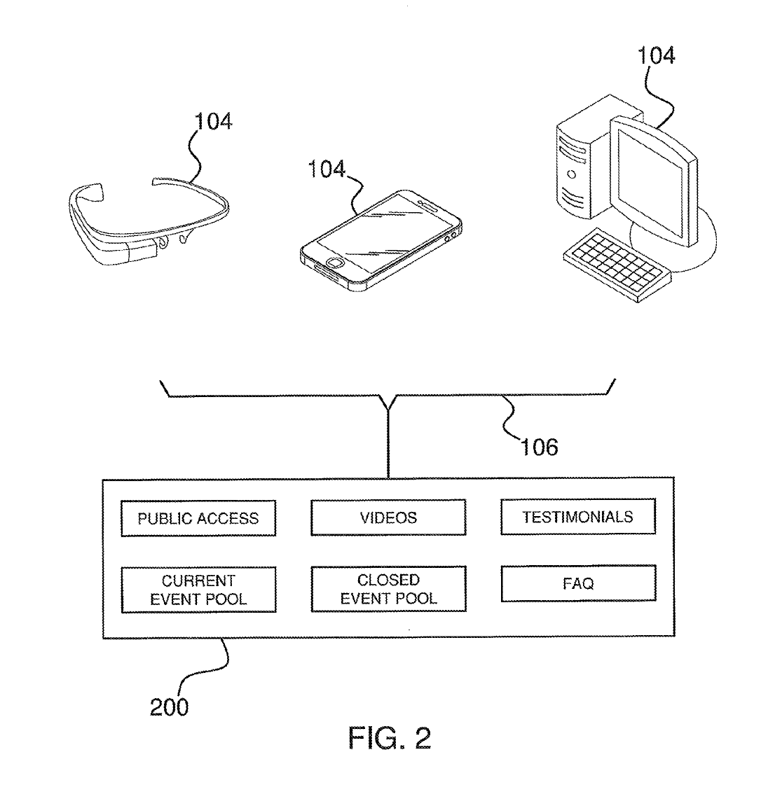

In FIG. 2 there is diagrammatically illustrated a web portal according to an embodiment and designated as 200. The web portal 200 is accessed via the internet 106 using a member computer 104, which is representatively illustrated as including a headgear, portable computing device, and a desktop computer. The web portal 200 will have various modules, representatively shown as public access 202, videos 204, testimonials 206, member groups that are open for enrolment 208, member groups that are closed for enrolment 210, and an FAQ 212. The web portal 200 is capable of having other modules as required to implement various aspects of the system and method. For example, the web portal will include the necessary payment systems and money handling systems for funding member accounts, linking member accounts to other financial accounts held by members, e.g., savings account, checking account, etc.

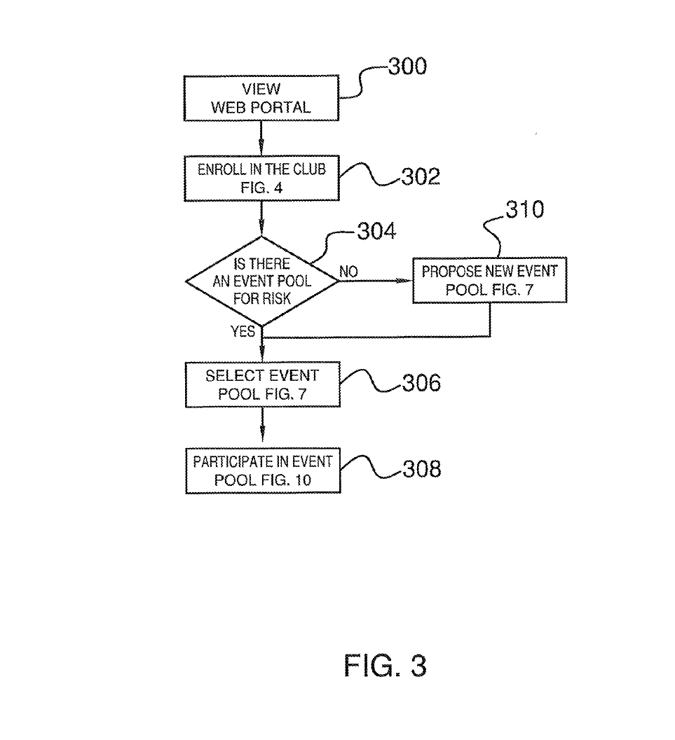

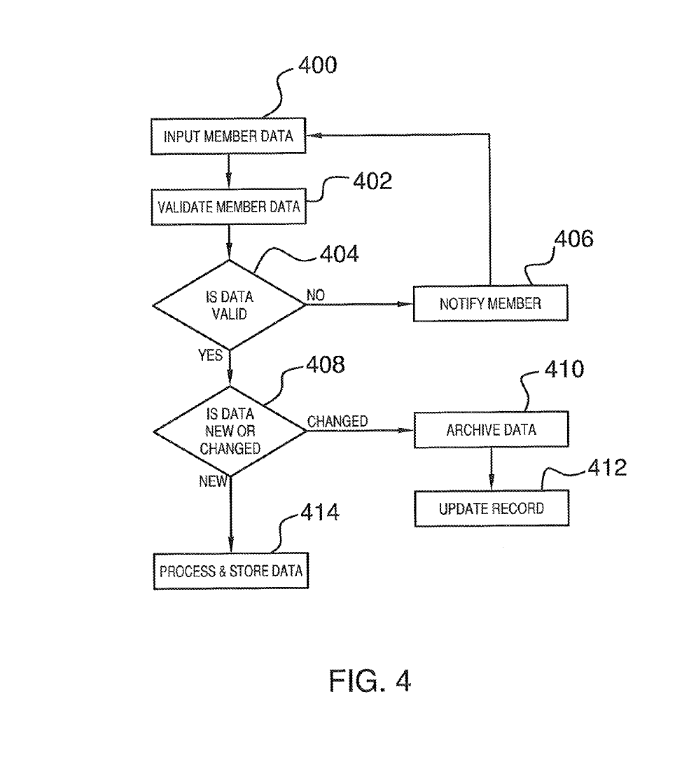

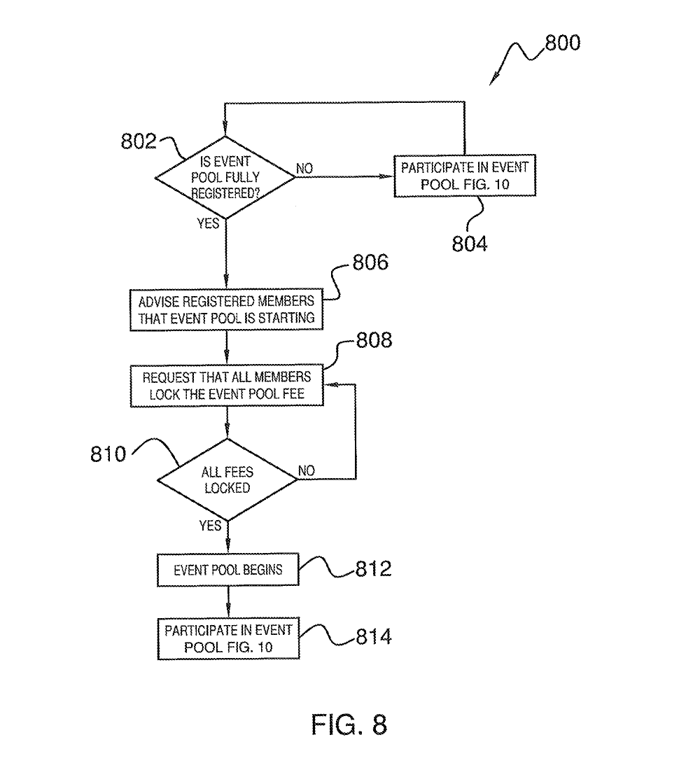

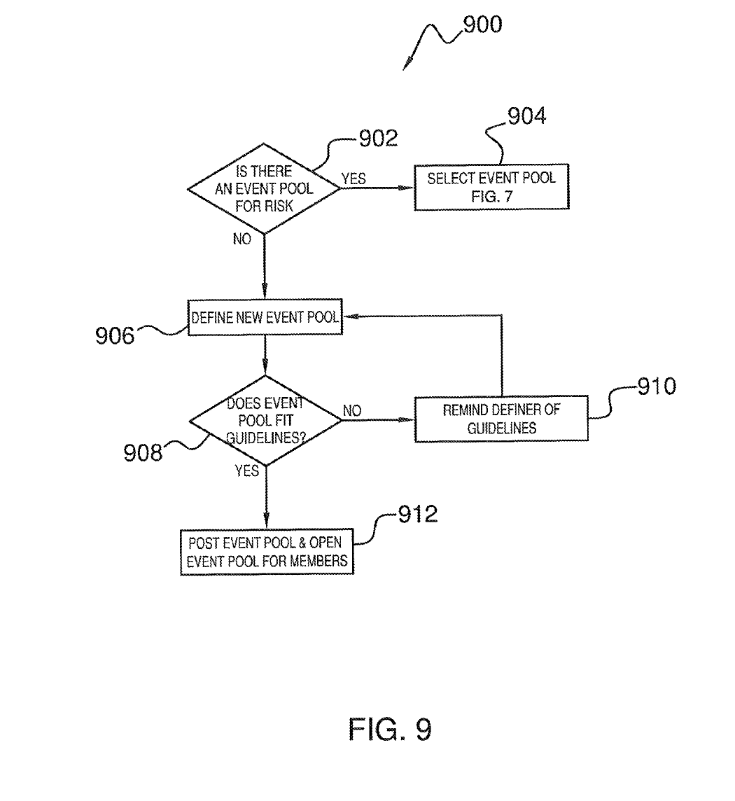

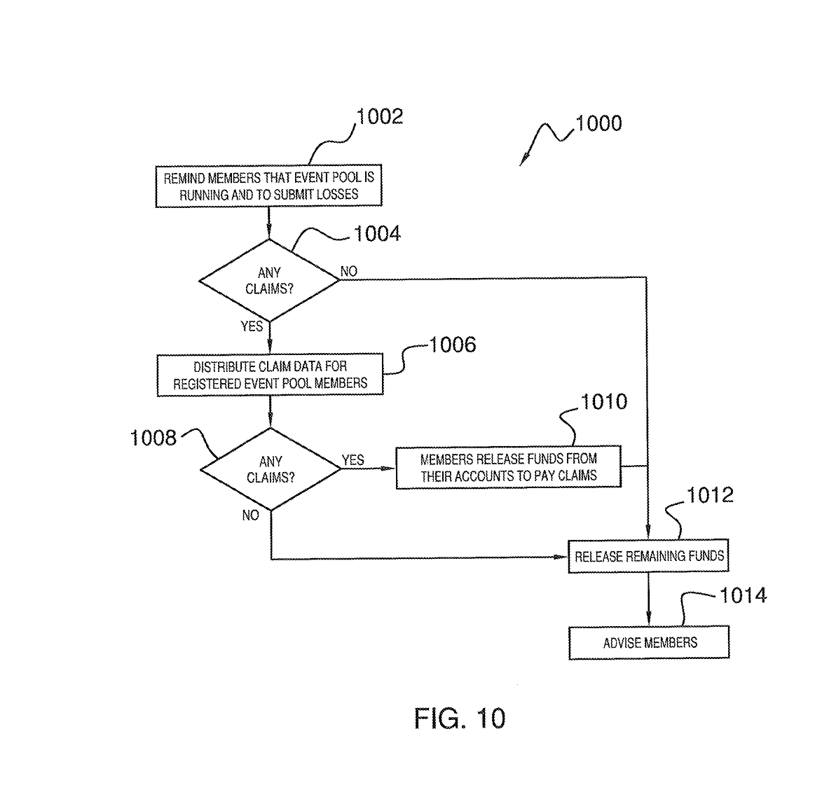

In FIG. 3 there is a flow-chart illustrating an exemplary user experience of a first time user visiting the web portal and joining the event pool network (club) according to an embodiment of the invention. At 300, a user with a risk and desiring to manage that risk visits the web portal using a computing device connected to the internet. The user may have been directed to the web port via another social network site through a recommendation of another user of that social network site, for example. At 302, the user joins the event pool social network of this invention, which is described in greater detail with reference to FIG. 4. At 304, the user, who is now a member, searches for an event pool that is associated with the risk that the member desires to manage and that is open for enrollment. If an event pool is available, the process proceeds to 306. At 306 the member selects that event pool for enrollment. Enrolment in an event pool is described in greater detail with reference to FIG. 8. Then at 308 the member participates within the selected event pool, which is discussed with reference to FIG. 10. If an event pool is unavailable the process proceeds to 310 to permit the member to request a new event pool. Creating an event pool is described in more detail with reference to FIG. 9.

In FIG. 4 there is a flow-chart illustrating an exemplary process of new member enrollment to the network according to an embodiment of the invention. At 400 a user is presented with various member data entry fields that the user must complete in order to enroll in the network. For example, member data includes data that is user specific, such as identifying information (name, address, email address, telephone number, date of birth, identification number), membership data (member level, member credits, ect.), and possibly other demographic data (smoker, sports played, ect.). At 402, the user submits the completed information to for verification. At 404, the data is verified against constraints associated with the data fields. For example, information entered into the field corresponding to the user's birth date is check to ensure that the information is in the correct format. If the entered data does not pass verification, the process proceeds to 406 where the user is notified of the error and requested to correct the error. If the data is verified, the process proceeds to 408 where the data is cross-checked with an existing member record to determine whether the user is updating information. If it is determined that the user is updating information, at 410 the previous member record is archived and at 412 the member record appended with the new information. If it is determined the user information is new, at 414 the information is stored in the member record.

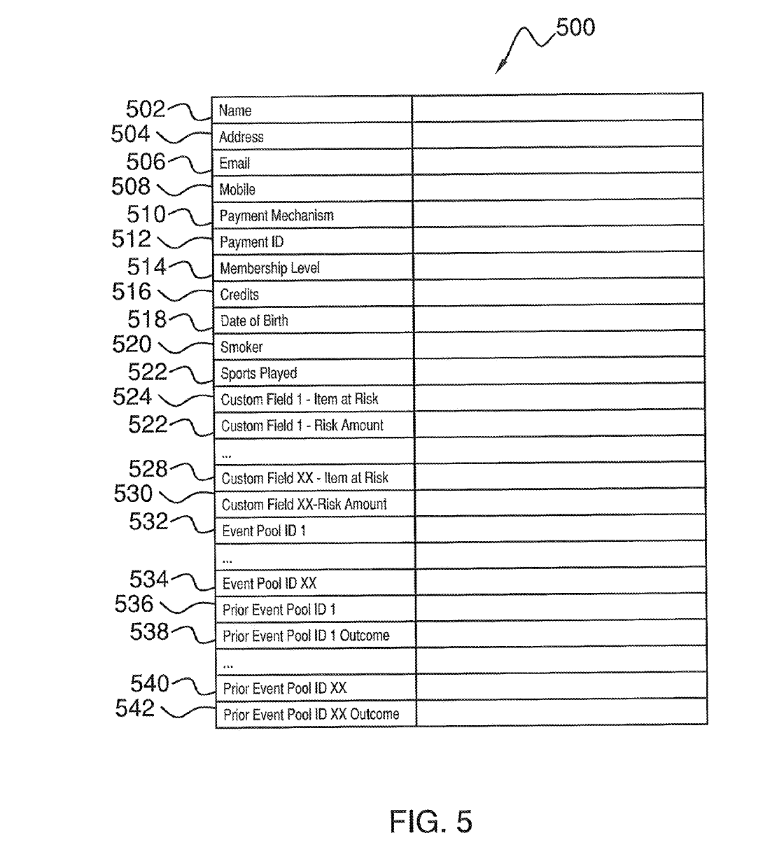

In FIG. 5 there is representatively illustrated a member record 500 according to an embodiment of the invention. For example, the member record 500 includes the following data: name 502, address 504, email address, 506, telephone number 508, payment type 510, payment ID, 512, membership level 514, member credits 516, date of birth 518, smoker 520, sports played 522, record entries 524-530 for risk event and risk value (plus additional records for each risk event), and record entries 532-542 for risk pool participation status and history.

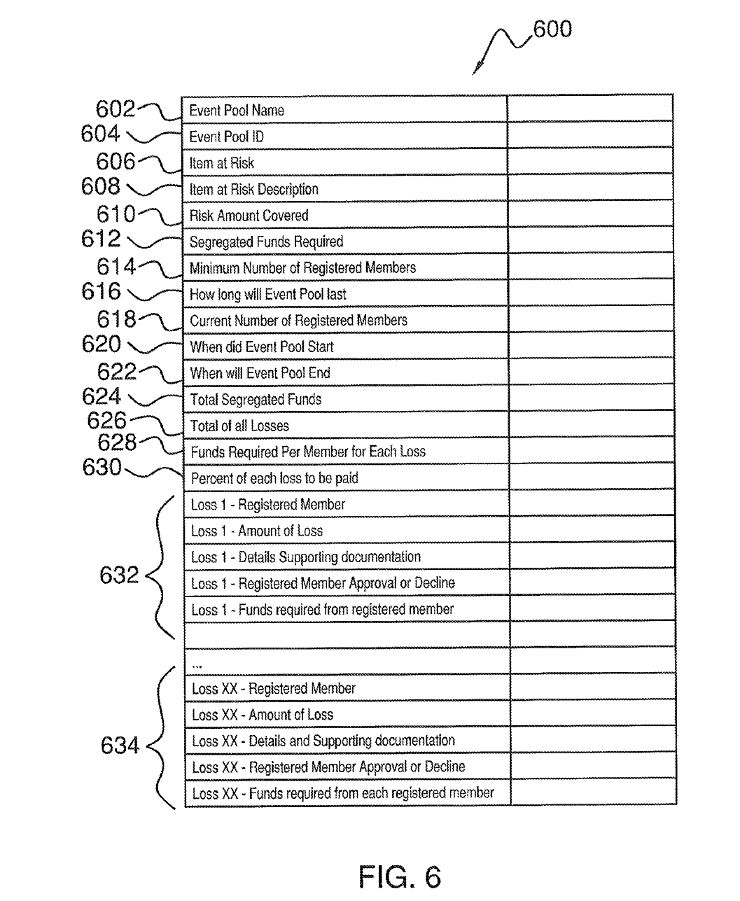

In FIG. 6 there is representatively illustrated a member group record 600 related to a event pool for a specified risk event. For example, the member group record 600 includes the following data: group name 602, group ID 604, risk event 606, description of risk event 608, benefit amount 610, segregated funds requirement 612, minimum number of participants required to fund the group 614, term of the group 616, number of currently enrolled participants 618, group start date 620, group term date 622, sum of all funds 624, sum of total losses experienced by the group 626, funds required per member participant for each loss 628, percent of each loss paid 630, and individual member loss records 632, including member name, loss amount, details and supporting documentation of the loss, whether participating members have voted to pay the benefit related to that loss, and funds required from each participating member to fund the benefit payment, and each additional member loss records 634.

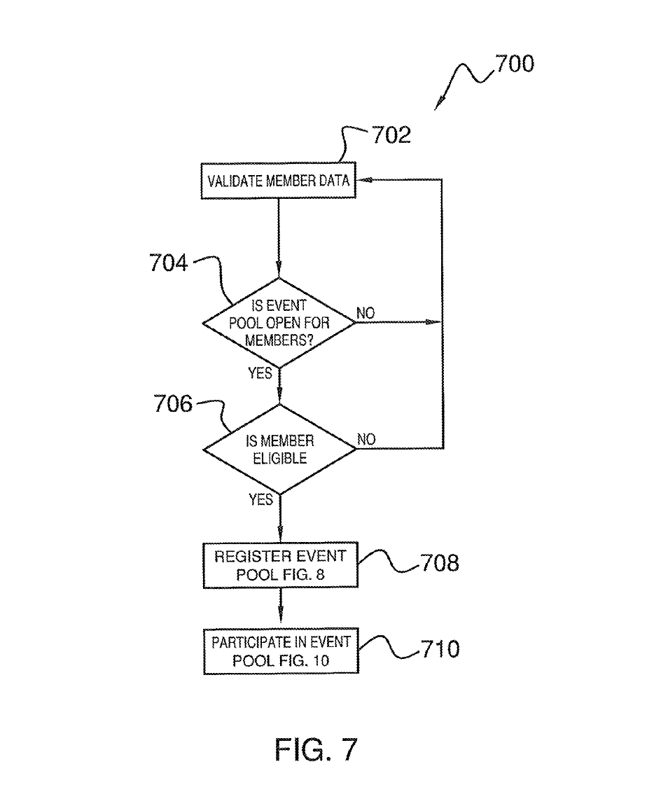

In FIG. 7 there is shown flow-chart illustrating an exemplary process 700 of member selecting an event pool to participate in according an embodiment of the invention. At 702, a member selects an event pool for participation. At 704, it is determined whether the selected event pool is open for members. If the selected event pool is not open for participation, the process notifies the member to select a different event pool. If the selected event pool is open for participation, the process moves to 706 where it is determined whether the member is eligible to participate in the selected event pool. If the member is not eligible to participate in the selected event pool, the process notifies the member to select a different event pool. If the member is eligible to participate in the selected event pool, the process moves to 708 where the member is then registered to participate in the event pool. After registering to participate in the event pool, the member is identified as participant of the event pool at 710.

In FIG. 8 there is shown flow-chart illustrating an exemplary process 800 of member registering to participate in a selected event pool according an embodiment of the invention. At 802 it is determined whether the number of registered participants of an event pool meets the requirement to fund and begin the term of the pool. If the number of registered participants does not meet the requirement, then at 804 the registration for the event pool remains open. If the number of registered participants does meet the requirement, then at 806 each participating member is notified that the event pool is about to start running. Then at 808, each participating member is requested to hold, freeze, or otherwise lock the enrollment fee from their funds account. At 810 it is determined whether each participating member has locked the enrollment fee from their funds account. If it is determined that each member has not locked the enrollment fee, another request is sent at 808. If it is determined that each member has locked the enrollment fee, then the process proceed to 812, where the term of the event pool begins, and then to 814 where members participate in the event pool.

In FIG. 9 there is shown flow-chart illustrating an exemplary process 900 of member creating a new event pool according an embodiment of the invention. If an event pool does not exist for the risk needs of a member, a member may define or create a new event pool for other members to join and find to manage the same risk. At 902, a member determines if an event pool exists for his or her need, and if an event pool is available the process moves to 904, where the member registers for the event pool as discussed above. If an event pool is not available, at 906 the member can create a new event pool and define the attributes of the event pool. Then at 908, the process determines whether the new event pool satisfies event pool requirements. If the event pool does not satisfy the requirements the process moves to 910. At 910, the process notifies the member of the attributes that do not satisfy the requirements and is requested to correct them. The corrected attributes are then rechecked at to 908. If it is determined the event pool does satisfy the requirements, then the process moves to 912. At 912, the new event pool is created and made available for other members to view and enroll.

In FIG. 10 there is shown flow-chart illustrating an exemplary process 1000 of member participation in an event pool according an embodiment of the invention. While the event pool is running (e.g., within its term), at 1002, the system will periodically remind members that they are participating in the event pool. At 1004, if a participating member encounters a loss, that member will submit a claim including proof of the loss. At 1006, the claim request and proof of loss are distributed to each participating member for determining the validity of the loss. At 1008, each participating member, after having reviewed the proof of loss of a claim makes a decision of whether to pay the benefit to the beneficiary. At 1010, if the participants decide to pay the benefit, funds are released to pay the benefit on the claim. At 1012, the remaining funds are calculated. And, at 1014 members are advised of the remaining funds and the payment or non-payment of the claim.

While the specific attributes, calculations and rules can be different for each risk pool member group, an example of a typical risk pool member group is provided below.

### Example

The following illustrated example is for a risk pool member group to manage the risk of a member's death. In this example, the provided benefit in case of a loss (e.g., a member's death) is $5000.00. The group requires 1,000 members to participate with an enrollment fee of $100.00 to fund and begin the group. The group also requires the participating members to have an age between 25-30 years and to identify who the benefit would be paid to (e.g., the beneficiary). Participation in the group also requires medical documentation that the member had no serious medical condition if a loss occurs. Additionally, the term of the group is for one year.

Each member will have the $100.00 enrollment fee held in his or her funds account, which cannot be moved from the funds account once it is held and during the one year term of the group. The $100.00 enrollment fee is invested in a risk free investment vehicle that, for this example, earns $5.00 payable at the end of the year.

Again, for this example, the group experienced one loss during the one-year term. The designated beneficiary must provide proof of the loss (e.g., a death certificate and the registered member's proof that he or she did not have any serious medical conditions) to the other members of the group. The group members then cast a vote on the validity of the proof of loss. If the proof of loss is found to be valid, then each member is required to pay a portion of the $5000.00 payable benefit. Each member's portion is determined by dividing the number of members participating in the group into the payable benefit. Hew, each member's payable portion is determined to be $5.00. This fee will be paid from the $100.00 enrollment fee that was held in the member's funds account. Then remaining $95 plus the investment earnings of $5.00, that is $100.00 per participating member is released from their funds account.

The system can have an unlimited number of event pools running simultaneously. And, a key aspect of the invention, is that funds from one event pool are never used to pay claim benefits on losses that occurred in a separate event pool. That is, funds that are paid by members to participate in a particular event pool are only used to pay benefits on losses that are associated with the particular event pool, the funds are never used to pay benefits on losses that are associated with a different event pool.

A number of embodiments of the present invention have been described. Nevertheless, it will be understood that various modifications may be made without departing from the spirit and scope of the invention. Accordingly, other embodiments are within the scope of the following claims.

1-8. (canceled)

9. A method, using collaborating on-line computer processors, configured to execute collaborative risk sharing among validated member participants willing to share the risk of the potential occurrence of a risk event suffered by a fellow member participant, said method comprising the steps of:
defining attributes of a community generated event pool having a member enrollment fee, a minimum number of online social networked member participants using a social networking device or a social media device, the duration of the event pool, and a claim benefit account, each member participant having a separate funds account;
funding the claim benefit account associated with the event pool from the funds account of each member participant;
receiving a claim request from a claimant member participant to recover a claim loss upon occurrence of the risk event;
validating the received claim request by a vote among non-claimant member participants; and
releasing funds from the claim benefit account to the claimant member participant equal to the claimed loss of the validated claim request.

10. The method of claim 9 further including the step of searching for an available event pool associated with the risk that a member participant desires to manage and cover.

11. The method of claim 9, wherein the event pool is customizable based on a request by at least one member participant for meeting the collaborative risk sharing needs of the community.

12. The method of claim 9 further including the step of proposing to create a new event pool by at least one member participant for other members to join if that event pool does not exist, thereby enabling the member participants to manage and cover new collaborative risking sharing events among validated member participants of the community.

13. The method of claim 12 further including the step of determining whether the new event pool satisfies event pool requirements.

14. The method of claim 9, wherein the step of releasing funds occurs at the end of the term of the pool event.

15. The method of claim 9, wherein the step of releasing funds occurs at the end of a predetermined length of time.

16. The method of claim 15, wherein the predetermined length of time is selected from the group consisting of: weekly, monthly, quarter-annually, semi-annually, and annually.

17. The method of claim 9, wherein, if the total claimed losses of the group exceed the event pool fund account, each claimed loss is reduced pro-rata so that the total claimed losses are less than or equal to the event pool fund account.

18. The method of claim 9, wherein the member participants agree to provide payment among all member participants in the event that one of the members suffers a loss due to a specific risk event, thereby enabling the financial risk to be transferred to the member participants instead of an insurance company.

19. The method of claim 9, wherein the event pool remains open for registration until the minimum number of participants and minimum event pool funding have been met.

20. The method of claim 9 further including the step of calculating and reporting to the non-claimant member participants the remaining funds available in the event pool fund account after the validated claim loss has been paid out to the claimant member participant.

21. The method of claim 20, wherein the validated claim loss or payable benefit is calculated by dividing the number of members participating in the event pool into the payable benefit.

22. The method of claim 20, wherein the member participants are advised of payments and non-payments associated with all claim requests.

23. The method of claim 9, wherein the collaborative risk sharing is executed within a peer-to-peer social network by means of the social networking device in multiple geographical regions.

24. The method of claim 9, wherein the computer-implemented method is configured to utilize online social networks and Internet media functions for directing individuals to the community generated event pool and for connecting said individuals to each other for collaborative risk sharing.

25. The method of claim 9 further including the step of determining whether the number of registered member participants of the event pool meet the requirements for funding and beginning the term of the pool.

26. The method of claim 9, wherein if the total risk impact of the community is less than expected, sharing the remaining funds equitably among the member participants.
